(19) United States
(12) Patent Application Publication
(10) Pub. No.: US 2005/0110651 A1
(43) Pub. Date: May 26, 2005

(54) Remotely controlling electronic devices

(76) Inventors: Thomas S. Martis, Chandler, AZ (US); Jun Shi, San Jose, CA (US); Animesh Mishra, Milpitas, CA (US)

Correspondence Address: TROP PRUNER & HU, PC, 8554 KATY FREEWAY, SUITE 100, HOUSTON, TX, 77024, US

(21) Appl. No.: 11/023,774

(22) Filed: Dec. 28, 2004

Related U.S. Application Data
(63) Continuation of application No. 09/208,339, filed on Dec. 9, 1998, now abandoned.

(51) Int. Cl. H04Q 1/00

(52) U.S. Cl. 340/825.69; 340/825.72; 340/825.22; 348/734

(57) ABSTRACT

A system enables electronic devices using a variety of different formats and having different control types to be controlled automatically by a remote control device. The system provides the necessary conversion information to the remote control device to enable a remote control device to control a number of different consumer electronic devices.

### BACKGROUND

This invention relates generally to remotely controlling electronic devices.

There are a very large number of commercially available remote control units (RCUs) that use an infrared signal to control an electronic device such as a television. Many users have elaborate systems of consumer electronic devices which may or may not be compatible with one another. For example, in a home theatre environment, the user may have a stereo sound system, a television, a video cassette recorder (VCR), a laser disc player and a digital video disc player (DVD). The user may desire to control each of these devices independently with a single RCU so that one device may be played when the others are off. This requires programming a number of functions into the RCU including on/off, channel change, volume change, program VCR and the like.

With conventional RCUs in systems with a number of remotely controlled electronic devices, the programming operation may be elaborate and time consuming. The user enters each device and programs the desired functionality into the RCU. The situation is complicated by the use of Infrared Data Association Control (IrDA-C) protocols. These protocols involve bi-directional signals which may not be compatible with the legacy unidirectional infrared control signals. Thus, different devices may use different infrared protocols and may require different command sets to operate them. All of this results in complexity to the user in programming the remote control to handle all of these possibilities.

The user may also wish to remotely control a computer system that operates in conjunction with a conventional television receiver. Computer systems, sometimes called set-top computer systems, may be of relatively small size, in some embodiments, and may be positioned on top of a television receiver. The addition of the set-top computer system adds still additional programming requirements on the remote control, further complicating user programming of a universal remote control which handles all of the different electronic devices. For example, the computer system may use the IrDA protocols while some other electronic devices may use the legacy protocols.

Thus, there is a continuing need for a way to program a remote control unit to handle a variety of electronic devices in a fashion which is easy and quick for the user.

### SUMMARY

In accordance with one embodiment, a method for enabling an electronic device to be controlled remotely includes receiving information about an electronic device. Based on this information, the code needed to allow the device to be controlled remotely is determined. The code is communicated to a remote control unit to enable the remote control unit to control the device.

### BRIEF DESCRIPTION OF THE DRAWINGS

FIG. 1 is a schematic depiction of one embodiment in accordance with the invention;

FIG. 2 is a flow chart for an embodiment such as the one shown in FIG. 1;

FIGS. 3A through 3C are depictions of graphical user interfaces useful with the embodiments shown in FIGS. 1 and 2;

FIG. 4 is a flow chart for another embodiment of the invention;

FIG. 5 is a flow chart for still another embodiment of the invention;

FIG. 6 is a graphical user interface that may be used in another embodiment of the invention; and

FIG. 7 is a block diagram showing the RCU and set-top computer system shown in FIG. 1.

### DETAILED DESCRIPTION

A system 10 for commonly controlling electronic devices includes a remote control unit (RCU) 12 which may control an electronic device such as an audio/visual (A/V) receiver 14, a set-top computer system 16 and a television receiver 18. A variety of other electronic devices may also be controlled by the RCU 12 including a VCR, a DVD player, a stereo system, or a compact disc (CD) player, as additional examples. The RCU 12 is automatically programmed to operate the desired electronic devices through interaction with the system 16.

The system 16 may prompt the user to input information about the devices which the user wishes to have the RCU control. The system 16 may then send information to the RCU 12 to enable the RCU 12 to control those devices regardless of whether the devices are legacy devices or devices which use the IrDA protocols (or some other protocol).

While the present invention is described in connection with several embodiments using infrared controlled devices, the same principles may be applied using radio-frequency controls such as those used in the Bluetooth radio-frequency signals. The Bluetooth system is described at {www.bluetooth.com}.

The system 16 may also be coupled to a network 20. The network connection may enable the system 16 to download additional information to control various remotely controllable devices. The network connection may couple the system 16 to the Internet for example.

The RCU 12 may include a plurality of buttons which allow control over the various functions of remotely controllable devices. For example, the RCU 12 may have buttons which allow a device type such as “TV” or “stereo receiver” to be entered. Thus, when the user wishes to control a particular device, the user may simply press the button associated with that device, such as the TV. The RCU 12 may also include buttons to select different channels, buttons to control volume, and buttons to remotely control other potential functions of various electronic devices.

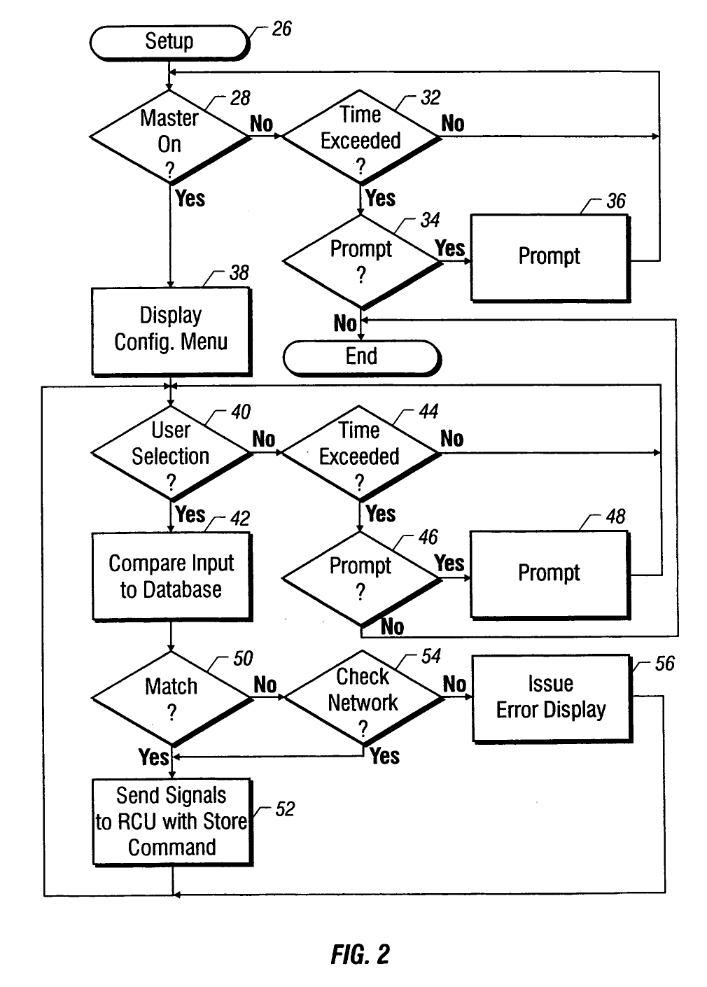

Referring now to FIG. 2, setup software 26, which may be resident on the system 16, allows automatic control of electronic devices. In one embodiment of the invention, the flow may begin by determining whether a master (which may be the system 16) has been turned on by a slave (which may be the RCU 12) as determined in diamond 28. If so, the receiver 18 or another display device may be caused to display a configuration menu, as indicated at block 38.

If the master has not been turned on by the slave, a check at diamond 32 determines whether a preset time limit has been exceeded. If not, the flow cycles back to wait for the operation of the master by the slave. If the time period has been exceeded, a check at diamond 34 determines whether a prompt should be provided. If the elapsed time exceeds still another limit, the prompt may not be provided and the flow may be terminated.

Otherwise, the prompt may be provided as a graphical user interface, for example, asking the user to operate the master using the remote control. This may involve turning the master back off and operating it “on” using the remote control.

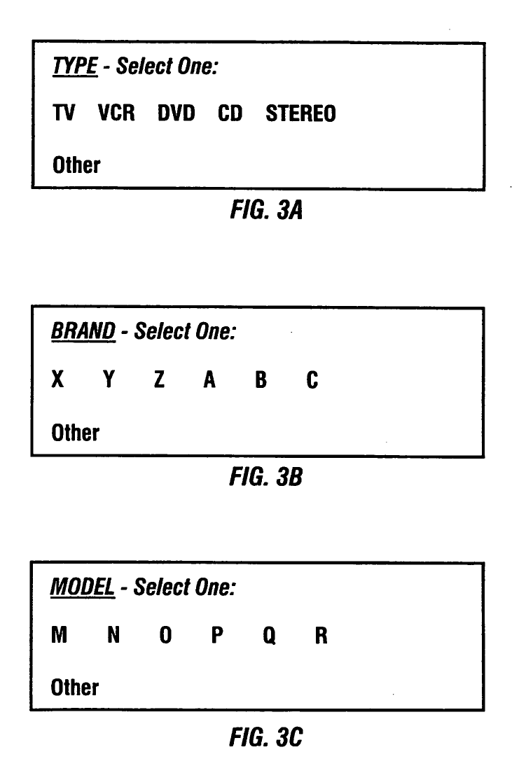

The configuration menu may allow the user to input the type of devices which the user wishes to automatically control using the RCU 12. For example, referring to FIG. 3A, a graphical user interface, displayed on the television receiver 18, may ask the user to input the type of device, be it a TV, a VCR, a DVD player, a CD player or a stereo system. Otherwise, the user can input “other” and an additional drop-down menu may be provided or the user may be asked for additional information.

Once the user has selected the device type, the system automatically provides a list of common manufacturers of the type of device selected using a database provided with the system 16, as illustrated in FIG. 3B. Again, the user has the option to select “other”, and when so selected, the system may either access additional information or display an additional menu of other manufacturers.

Referring to FIG. 3C, a graphical user interface may also ask the user to select from among the models available for the given type of device and the selected manufacturer. The user again may select the desired option or may be provided with additional options by selecting the “other” option.

The user may input the selections using the RCU 12. This may be done using a mouse style pointing system or, if desired, each potential selection may be associated with a number or a letter which then may be entered using the keypad provided on the RCU 12.

Referring back to FIG. 2, at diamond 40 a check determines whether the user has made all of the required selections. If so, each selection is compared to a database of known information. If not, a check at diamond 44 determines if a preset time period has been exceeded. If the time has elapsed, a screen prompt may be issued as indicated in diamond 46 and block 48.

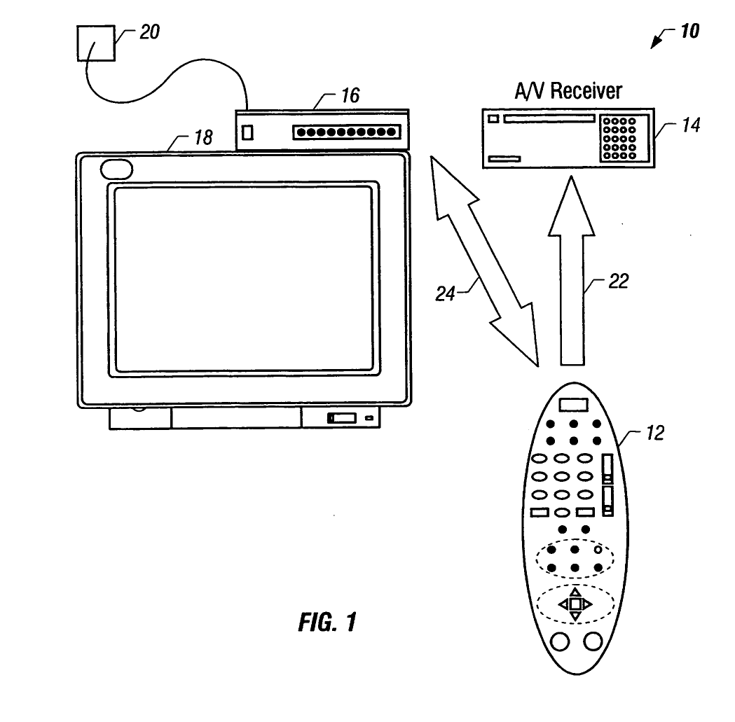

From the database, the required remote control codes can be determined by the system. If each of the selections matches an existing database entry, the appropriate signal information is sent to the RCU 12 by the system 16. In other words, the RCU 12 may be provided with protocols to control a given device. Referring to FIG. 1, the information may be provided along the path 24 from the device 16 to the device 12, thereby enabling the device 12 to control the device 14 as indicated at 22. The RCU 12 may also be commanded to store the information in an appropriate format on the RCU 12.

If the user selections do not match any existing database entries for known devices, a network check may be initiated as indicated at diamond 54. In this case, the system 16 may communicate with an external network, for example over a modem connection, to determine whether additional information is available. This modem connection may connect to an additional database, for example over a direct telephone link to a server or over the Internet. In such case, additional information about the requested device may be downloaded to the system 16 allowing the system 16 to proceed, as indicated in block 52, to provide the RCU with the desired information. If no such information can be located, a graphical user interface indicating an error condition may be displayed, as indicated at block 56. In this case, the user may be prompted to program the device in the conventional fashion since the system is unable to automatically provide the information to the RCU 12.

In most cases, the tedious task of programming the various devices may be performed in an automated fashion using the databases and software associated with the system 16. This operation may occur seamlessly and without substantial user involvement in the programming of the RCU 12.

The RCU 12 may operate in one of at least two different fashions. The RCU may have dedicated buttons that correspond to particular controlled devices. For example, the RCU may contain a button that is labeled “TV.” When the TV button is pushed, the appropriate commands are sent to the master informing the master that the user now wishes to control the TV. The next button that is pushed, for example, the channel up button, causes the appropriate command to be sent to the master telling it, for example, that the user wishes to go to the next highest channel. The master in turn sends the RCU the necessary codes to increment the channel on the TV. The RCU then takes these codes and sends them, for example using a unidirectional infrared signal, to the TV using the protocols stored in the RCU's memory.

Alternatively, the RCU may contain sufficient memory that the master may send the RCU both the protocols and the necessary codes to control the devices. The RCU saves this information in its local memory. Then, when the user wishes to change the channel on the TV, the user pushes the TV button and this causes the RCU to enter a mode which controls the TV using the pre-sent protocols. Then, when the user pushes the channel up or other control button, the remote control fetches the necessary codes from local memory and sends a unidirectional infrared message using the protocol that is also stored locally on the RCU.

The difference between the two approaches is that in the first case, the master feeds the information to the RCU each time the RCU needs information. In the second case, the master feeds the information needed to do all the different controls for a given device initially, and then the device handles those protocols on its own. In one embodiment of the invention, the information may be provided from the master to the RCU each time the system is operated so that it is not necessary to discard the information when it is desired to switch controlled devices.

In another embodiment of the invention, control over electronic devices may be initiated from a remote location. For example, using a network communication protocol such as electronic mail (e-mail), a message may be sent over the network 20 to a receiver, such as the system 16. This message may be recognized by the system 16 as a command, and the system 16 may implement the appropriate action in accordance with the command. For example, the system 16 may issue commands to the RCU 12 to appropriately control the A/V receiver 14, as one example. Alternatively, the system 16 may directly send commands to a receiver 14.

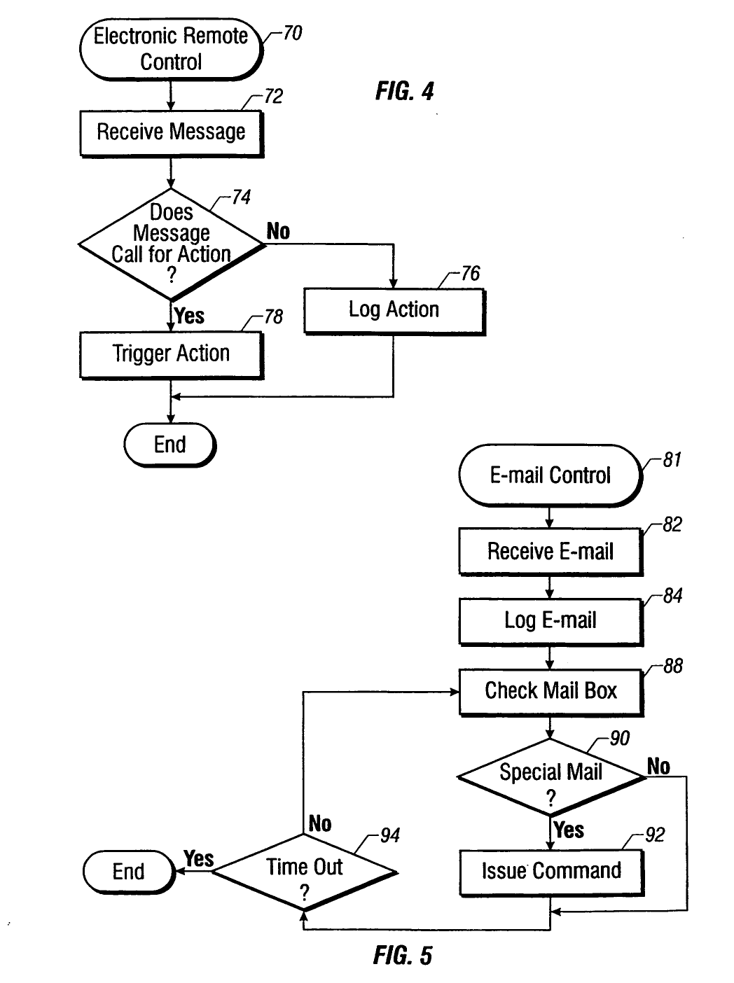

Referring to FIG. 4, a message may be received by the system 16 from the network 20 as indicated at block 72. The system 16 determines whether the message calls for a particular action (diamond 74). For example, the message may be intended to communicate information to a receiver. Alternatively, the message may include commands intended to be implemented by the system 16. If the message is merely for communication purposes, it may be logged (block 76) and the flow is complete. If, however, the message is intended to initiate action at the remote location, the action may be implemented (block 78).

The message to be received by the system 16 may be conveyed over the telephone lines, for example, by voice or other means such as e-mail. The message may be deciphered and a determination may be made as to whether the message conveys information only or whether it seeks to initiate an action. For example, the message may contain a header that includes a field which may be used to indicate whether action is intended or merely information is to be exchanged. Thus, when a particular header is recognized, a command may be issued to initiate action. The data contained in the header may provide information about the particular activity to be implemented. This information may be deciphered and the appropriate command may be issued.

As another example, in the case of the system shown in FIG. 1, an e-mail message received over the network 20 may be deciphered. If the message calls for programming the A/V receiver 14, the appropriate IrDA-C commands 24 may be issued to the RCU 12, as illustrated in FIG. 1. The RCU may then issue commands 22 in the appropriate format to the receiver 14.

As still another alternative, a message containing command information may be transmitted to a separate address that is distinct from the address where messages that are of a non-command format are sent. For example, a separate “command” e-mail message box may be maintained in order to receive command messages. Thus, whenever a message is received in the command message box, a command may be issued by the system 16. Again, data associated with the message may be used to determine the appropriate command. For example, the message may include script that causes an appropriate action to occur.

Similarly, where a voice command is received, speech-to-text translation software may be used to determine whether or not the message is a command message or an information message. The converted text may be scanned for appropriate command language. For example, if the message is intended to be a command message, an appropriate statement or code word may be provided. Then, the caller may be prompted to provide specific information in response to automated questions. The responses may be stored in fields that may be decoded to provide the appropriate actions.

Referring now to FIG. 5, initially an electronic mail message may be received as indicated in block 82. The message may then be logged in a mailbox (block 84) and the mailbox may be periodically checked for new messages (block 88). When a new message is identified, a determination (diamond 90) is made as to whether the message is a special message calling for an action. If the message is merely informational, no further steps may be necessary. However, if a special message is received, which may be determined as described previously, the appropriate commands may be issued (block 92). After a check to see if a predetermined time has elapsed (diamond 94), the flow may cycle back to recheck the mail box (block 88).

While one embodiment of the invention may involve infrared commands from the system 16 to the RCU 12 and infrared commands from the RCU 12 to the device 14, the commands may also be in other formats including radio-frequency formats. In addition, some of the commands may be in a radio-frequency format while other commands are in an infrared format, as another example. In one advantageous embodiment, the system 16 may initiate radio-frequency commands which may be received by an RCU 12 or an appropriate pad device. The RCU 12 (or pad device) may decode the radio-frequency commands 24 and issue appropriate infrared commands 22 to the controlled device. The use of radio-frequency commands may advantageously allow devices in different rooms to be controlled from a central location.

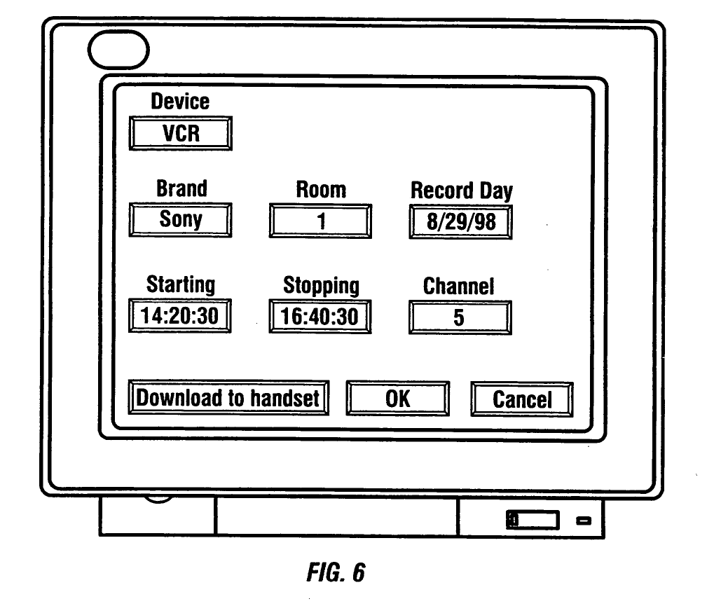

In accordance with still another embodiment, the user interface as shown in FIG. 6, may include a plurality of icons or indicia that prompt the user to input information about the type of device to be controlled, its brand, and the room within the building in which it is located. In the illustrative example, the user may be prompted for information necessary to program a VCR. Thus, the user may be prompted for start and stop time, channel and record day.

When the user inputs a given room number or identifier, the system may have a database containing information about what electronic devices may be controlled in a given room. The system 16 may then issue the appropriate commands to control the devices in the selected room.

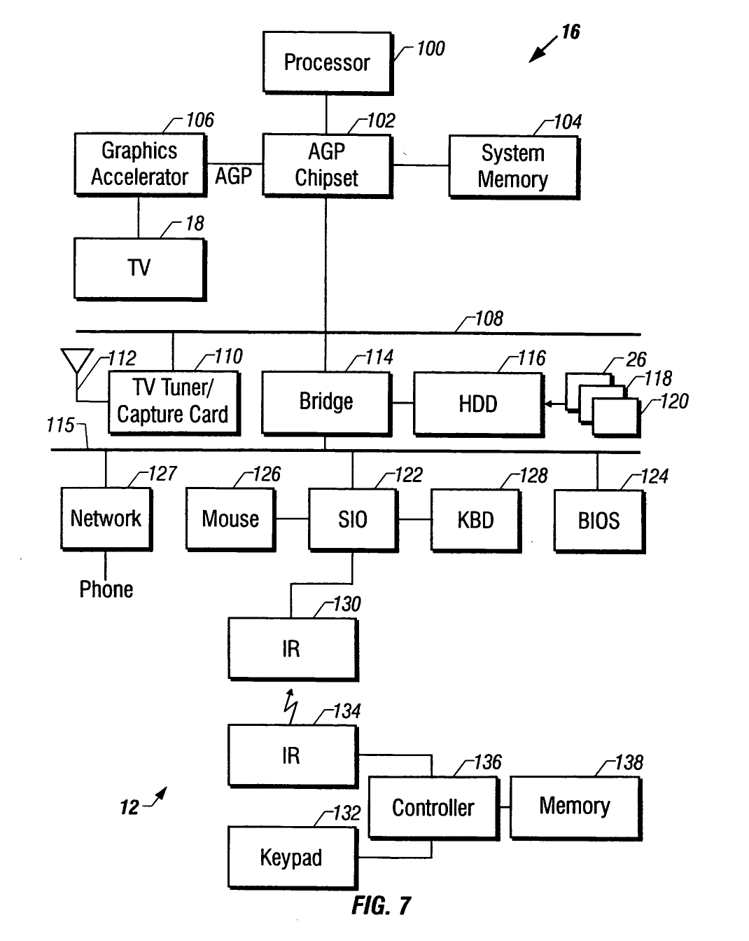

Referring now to FIG. 7, an example of a system for providing the capabilities described previously may involve either a computer, a television receiver, a set-top computer system or another appliance. The illustrated system 16 includes a processor 100 coupled to an accelerated graphics port (AGP) chipset 102. AGP is described in detail in the Accelerated Graphics Port Interface Specification, Revision 2.0, published in May 1998 by Intel Corporation of Santa Clara, Calif.

The AGP chipset 102 may in turn be coupled to system memory 104 and a graphics accelerator 106. The graphics accelerator 106 may be coupled to a TV receiver 18.

The chipset 102 may also be coupled to a bus 108 which in turn may be coupled to a TV tuner/capture card 110. The tuner/capture card 110 may be coupled to a television input 112. The input 112 may, for example, be a conventional TV antenna, a satellite antenna, a cable connection, or other television inputs. The card 110 may receive television signals in one video format and may convert them into a format used by the system 16.

The bus 108 may also be coupled to another bridge 114 which in turn couples a hard disk drive 116. The hard disk drive 116 may store the software 26, the database 118 associated with the graphical user interfaces shown in FIG. 3, and the software 120 necessary to download additional information from a network. The hard disk drive 116 may also store the software 70 and/or 81.

The bridge 114 may be coupled to a bus 115 coupled to a serial input/output (SIO) device 122, a network 127 and a basic input/output system (BIOS) 124. The SIO device 122 may interface to a mouse 126 and a keyboard 128. The SIO device may also be coupled to the RCU 12 through an interface 130 to enable the system to receive inputs from a wireless remote control. The network 127 may be, for example, a connection to a telephone network or a local area network. As mentioned previously, the RCU 12 may provide either infrared or radio-frequency signals which may be received by the interface 130.

An infrared interface 130 may, for example, be in accordance with the Infrared Data Association protocols such as, for example, the Serial Infrared Physical Layer Link Specification, version 1.2, dated Nov. 30, 1997. The remote control unit 12 may include a keypad 132 coupled to an infrared transmitter 134 that transmits the infrared signals received by the interface 130. A controller 136 may be provided to control both the transmitter 134 and to receive information from the keypad 132. The controller 136 may have associated with it memory 134, which in one illustrated embodiment may be nonvolatile random access memory (NVRAM). The memory 134 may store the information provided by the system 16 to enable the RCU 12 to provide the appropriate signals to particular electronic devices to be controlled.

The graphical user interfaces described herein are visual representations of memory states. The graphical user interfaces displayed on the display 18 may be stored in a memory such as one or more of the memories 104 or 116.

While the present invention has been described with respect to a limited number of embodiments, those skilled in the art will appreciate numerous modifications and variations therefrom. It is intended that the appended claims cover all such modifications and variations as fall within the true spirit and scope of the present invention.

1-27. (canceled)

28. A method comprising:
receiving information in a system about an electronic device;
based on the information, determining if a code for remote control of the electronic device is present in the system;
if the code is not present in the system, obtaining the code from a remote database and storing the code in the system; and
automatically communicating the code from the system to a remote control unit to enable the remote control unit to control the electronic device.

29. The method of claim 28, wherein receiving information about an electronic device includes displaying a graphical user interface on a display associated with the system having data entry fields and receiving information from a user in said data entry fields.

30. The method of claim 28, further comprising receiving the information from the remote control unit.

31. The method of claim 30, wherein receiving the information comprises receiving configuration information from the remote control unit under control of a user.

32. The method of claim 31, further comprising determining if the code is present and automatically communicating the code without further user action.

33. The method of claim 31, wherein the configuration information comprises information of an electronic device of the user.

34. The method of claim 28, further comprising accessing the remote database via the Internet.

35. The method of claim 28, wherein automatically communicating the code to the remote control unit includes providing only data for the remote control unit to implement a particular command.

36. The method of claim 28, wherein automatically communicating the code to the remote control includes providing a protocol to enable a particular electronic device to be controlled by said remote control unit and causing said remote control unit to store said protocol.

37. An article comprising a machine-accessible storage medium containing instructions that if executed enable a system to:
receive information in a system about an electronic device;
based on the information, determine if a code for remote control of the electronic device is present in the system;
if the code is not present in the system, obtain the code from a remote database and store the code in the system; and
automatically communicate the code from the system to a remote control unit to enable the remote control unit to control the electronic device.

38. The article of claim 37, further comprising instructions that if executed enable the system to receive the information from the remote control unit.

39. The article of claim 37, further comprising instructions that if executed enable the system to determine if the code is present and automatically communicate the code without further user action.

40. The article of claim 39, further comprising instructions that if executed enable the system to provide only data for the remote control unit to implement a particular command.

41. The article of claim 39, further comprising instructions that if executed enable the system to provide a protocol to enable a particular electronic device to be controlled by said remote control unit and cause said remote control unit to store said protocol.

42. A system comprising:
a master device to receive a request for control code information corresponding to a user selection on a remote control unit and provide the control code information to the remote control unit; and
the remote control unit to remotely control an electronic device using the control code information provided by the master device.

43. The system of claim 42, wherein the remote control unit includes dedicated user input selectors for a plurality of electronic devices.

44. The system of claim 42, wherein the remote control unit to send the control code information to the electronic device using a protocol stored in the remote control unit.

45. A method of controlling an electronic device at a remote location comprising:
receiving an electronic mail message from an electronic network at a receiver proximate to said electronic device;
determining whether the electronic mail message provides information or requests an action; and
if said electronic mail message requests an action, causing said receiver to issue a command to said electronic device.

46. The method of claim 45, wherein the determining is performed in the receiver.

47. The method of claim 46, wherein the receiver comprises a set-top box.

48. The method of claim 47, further comprising directly controlling the electronic device via the command.

49. The method of claim 45, further comprising logging the electronic mail message in the receiver if the electronic mail message provides information.

50. The method of claim 45, further comprising analyzing a header of the electronic mail message to determine whether the electronic mail message provides information or requests an action.

51. The method of claim 45, further comprising sending the electronic mail message to a first location of the receiver if the electronic mail message provides information and to a second location of the receiver if the electronic mail message requests an action.
